(19) United States
(12) Patent Application Publication
(10) Pub. No.: US 2025/0015469 A1
(43) Pub. Date: Jan. 9, 2025

(54) METHOD FOR MANUFACTURING ENERGY STORAGE DEVICE AND ELECTROLYTE SOLUTION FILLING DEVICE

(71) Applicant: GS Yuasa International Ltd., Kyoto-shi, Kyoto (JP)

(72) Inventors: Kazuya OKABE, Kyoto (JP); Ryoichi OKUYAMA, Kyoto (JP)

(21) Appl. No.: 18/697,935

(22) PCT Filed: Sep. 21, 2022
(86) PCT No.: PCT/JP2022/035108

§ 371 Date: Apr. 2, 2024

(30) Foreign Application Priority Data
Jun. 10, 2021 (JP) 2021-165080

(51) Int. Cl. H01M 50/609; H01M 50/673

(52) U.S. Cl. CPC H01M 50/609; H01M 50/673

(57) ABSTRACT

A method for manufacturing an energy storage device according to one aspect of the present invention includes: degassing an inside of an element case in which an electrode assembly including a positive electrode and a negative electrode is housed and a plurality of electrolyte solution filling ports are provided on one surface; and injecting the electrolyte solution from one electrolyte solution filling case filled with the electrolyte solution into the inside of the degassed element case through the plurality of electrolyte solution filling ports.

### TECHNICAL FIELD

The present invention relates to a method for manufacturing an energy storage device and an electrolyte solution filling device.

### BACKGROUND ART

Energy storage devices such as lithium ion secondary batteries have been, because their high energy densities, heavily used for electronic devices such as personal computers and communication terminals, automobiles, and the like. In addition, lithium ion capacitors and the like have been also widely used as energy storage devices other than the lithium ion secondary batteries.

In general, an energy storage device is manufactured by housing an electrode assembly in which a positive electrode and a negative electrode are stacked with a separator interposed therebetween in a case, and then injecting an electrolyte solution into the case (see Patent Document 1). As a result, the energy storage device in a state where the inside of the electrode assembly is impregnated with the electrolyte solution is obtained.

### PRIOR ART DOCUMENT

### Patent Document

Patent Document 1: JP-A-2001-110399

### SUMMARY OF THE INVENTION

### Problems to be Solved by the Invention

In the manufacture of the energy storage device, in order to efficiently inject the electrolyte solution into an element case and impregnate the electrode assembly with the electrolyte solution, the inside of the element case may be depressurized and the electrolyte solution may be injected. However, particularly when the electrode assembly is large, it takes time to impregnate the inside of the electrode assembly with the electrolyte solution, and the electrolyte solution is not sufficiently impregnated up to a central portion of the electrode assembly, so that air or the like may remain as bubbles (gas pool) in the electrode assembly.

The present invention has been made in view of the circumstances as described above, and an object of the present invention is to provide a method for manufacturing an energy storage device and an electrolyte solution filling device capable of efficiently filling an electrolyte solution into an element case in which an electrode assembly is housed.

### Means for Solving the Problems

A method for manufacturing an energy storage device according to one aspect of the present invention includes: degassing an inside of an element case in which an electrode assembly including a positive electrode and a negative electrode is housed and a plurality of electrolyte solution filling ports are provided on one surface; and injecting the electrolyte solution from one electrolyte solution filling case filled with the electrolyte solution into the inside of the degassed element case through the plurality of electrolyte solution filling ports.

An electrolyte solution filling device according to another aspect of the present invention is used when an electrolyte solution is injected into an element case in which an electrode assembly including a positive electrode and a negative electrode is housed and a plurality of electrolyte solution filling ports are provided, and includes one electrolyte solution filling case, and a pipe for connecting the one electrolyte solution filling case and the plurality of electrolyte solution filling ports.

### Advantages of the Invention

According to one aspect of the present invention, it is possible to provide a method for manufacturing an energy storage device and an electrolyte solution filling device capable of efficiently filling an electrolyte solution into an element case in which an electrode assembly is housed.

### BRIEF DESCRIPTION OF THE DRAWINGS

FIG. 1 is a flowchart showing one embodiment of a method for manufacturing an energy storage device.

FIG. 2 is a first explanatory view of one embodiment of the method for manufacturing the energy storage device.

FIG. 3 is a second explanatory view of one embodiment of the method for manufacturing the energy storage device.

### MODE FOR CARRYING OUT THE INVENTION

First, outlines of a method for manufacturing an energy storage device and an electrolyte solution filling device disclosed in the present specification will be described.

[1] A method for manufacturing an energy storage device according to one aspect of the present invention includes: degassing an inside of an element case in which an electrode assembly including a positive electrode and a negative electrode is housed and a plurality of electrolyte solution filling ports are provided on one surface; and injecting the electrolyte solution from one electrolyte solution filling case filled with the electrolyte solution into the inside of the degassed element case through the plurality of electrolyte solution filling ports.

According to the method for manufacturing an energy storage device according to [1], the electrolyte solution can be efficiently injected into the element case in which the electrode assembly is housed. The reason why the method for manufacturing the energy storage device exerts such an effect is presumed as follows. First, in the method for manufacturing an energy storage device, a plurality of electrolyte solution filling ports are provided on one surface of the element case, and it is efficient because an electrolyte solution is injected through the plurality of electrolyte solution filling ports. Here, it is also conceivable to inject the electrolyte solution using a plurality of electrolyte solution filling cases corresponding to the respective electrolyte solution filling ports. However, in this case, when all the electrolyte solution in one of the plurality of electrolyte solution filling cases is injected first, a degree of vacuum inside the element case decreases by a volume of the empty electrolyte solution filling case and a pressure inside the electrolyte solution filling case, the injection of the electrolyte solution from the remaining electrolyte solution filling cases does not sufficiently proceed, and in some cases, all the electrolyte solution may not be injected. On the other hand, in the method for manufacturing the energy storage device, since the electrolyte solution is injected from one electrolyte solution filling case to the plurality of electrolyte solution filling ports, the injection of the electrolyte solution from the plurality of electrolyte solution filling ports can be easily completed almost simultaneously, and the whole amount of the electrolyte solution in the electrolyte solution filling case can be effectively injected. In addition, the use of one electrolyte solution filling case also has advantages of simplifying the structure of the electrolyte solution filling device, facilitating pressure adjustment, and the like.

[2] In the method for manufacturing an energy storage device according to [1], it is preferable that the one electrolyte solution filling case is further filled with carbon dioxide at the time of the injection. In such a case, air bubbles remaining in the electrode assembly can be reduced. When the energy storage device is used in a state where the air bubbles remain in the electrode assembly, a charge-discharge reaction does not occur in the positive electrode and the negative electrode in a portion facing the air bubbles, and a current tends to concentrate in a portion around the air bubbles. In particular, when the energy storage device is a lithium ion energy storage device, precipitation of metallic lithium or the like is likely to occur on the negative electrode surface of the portion around the air bubbles. The precipitation of metallic lithium is not preferable because it causes deterioration in charge-discharge performance and the like. The reason why the air bubbles remaining in the electrode assembly can be reduced when the one electrolyte solution filling case is filled with carbon dioxide together with the electrolyte solution is presumed as follows. When the electrolyte solution and carbon dioxide are injected into the element case in which the electrode assembly is housed and degassed, even when the air bubbles remain in the electrode assembly after injection, most of the air bubbles remain as carbon dioxide bubbles. The carbon dioxide bubbles are shrunk, reduced, or eliminated as carbon dioxide reacts with lithium ions in the electrolyte solution or the like to form lithium carbonate and is fixed to the negative electrode surface during preliminary charging or the like described later. This reaction is considered to proceed by the following scheme in the presence of water in the electrolyte solution. In addition, although this reaction is a reaction in the electrolyte solution, it is considered that carbon dioxide has high solubility in a general electrolyte solution (nonaqueous electrolyte solution or the like), and the carbon dioxide in the electrolyte solution is consumed by this reaction, whereby the dissolution of carbon dioxide present as air bubbles in the electrolyte solution is promoted, and the air bubbles of carbon dioxide are shrunk, reduced or eliminated.

$${Li}^{+} + 2 {H}_{2} O \to LiOH \cdot {H}_{2} O + {H}^{+} \\ LiOH + {H}_{2} O + {CO}_{2} \to {LiHCO}_{3} + {H}_{2} O \\ 2 {LiHCO}_{3} \to {Li}_{2} {CO}_{3} + {H}_{2} O + {CO}_{2}$$

In addition, when the electrolyte solution and the carbon dioxide are injected into the element case using the electrolyte solution filling case filled with the electrolyte solution and the carbon dioxide, it is considered that the electrolyte solution and the carbon dioxide flow into the element case substantially simultaneously, and the carbon dioxide efficiently permeates into the electrode assembly together with the electrolyte solution. Therefore, by using the electrolyte solution filling case filled with carbon dioxide together with the electrolyte solution, it is possible to efficiently inject these into the element case.

The carbon dioxide filled in the electrolyte solution filling case is filled in the electrolyte solution filling case as a gas, and a part of the carbon dioxide may be dissolved in the electrolyte solution.

[3] In the method for manufacturing an energy storage device according to [1] or [2], it is preferable that the electrolyte solution filling case is filled with an electrolyte solution in an amount to be injected as the electrolyte solution in one operation at the time of the injection. In such a case, it is easy to control the injection amount of the electrolyte solution, and in particular, in a case where injection is performed in a plurality of operations, it is possible to efficiently perform the injection operation once with an accurate amount.

[4] In the method for manufacturing an energy storage device according to any one of [1] to [3], it is preferable that the one electrolyte solution filling case has a bottom surface provided with a plurality of discharge ports as many as the plurality of electrolyte solution filling ports of the element case, at the time of the injection, in a plurality of discharge ports of the one electrolyte solution filling case and the plurality of electrolyte solution filling ports of the element case, each pair is connected by a pipe, and the one electrolyte solution filling case is disposed such that the bottom surface is horizontal. As described above, by providing the plurality of discharge ports on the bottom surface of the electrolyte solution filling case and arranging the discharge ports such that the bottom surface becomes horizontal at the time of injection, the injection of the electrolyte solution from the plurality of discharge ports can be easily completed substantially simultaneously, and injection operation of the electrolyte solution is made more efficient.

[5] In the method for manufacturing an energy storage device according to [4], it is preferable that each of the pipes includes a valve, and the respective valves are simultaneously opened at the time of the injection. As a result, the electrolyte solution simultaneously flows out from the respective discharge ports on the bottom surface of the electrolyte solution filling case, and the injection operation of the electrolyte solution is made more efficient.

[6] In the method for manufacturing an energy storage device according to any one of [1] to [5], at the end of the injection, the inside of the one electrolyte solution filling case is preferably pressurized in a state where the one electrolyte solution filling case and the element case are communicated with each other. By performing such an operation, the electrolyte solution remaining in the electrolyte solution filling case flows out from the discharge port, and the inside of the electrode assembly is more sufficiently impregnated with the electrolyte solution. Therefore, by such an operation, the electrolyte solution in the electrolyte solution filling case can be sufficiently injected into the element case, and the air bubbles in the electrode assembly are further reduced.

[7] The method for manufacturing an energy storage device according to any one of [1] to [6] preferably further includes performing preliminary charging after the injection. In a case where the energy storage device is a lithium ion energy storage device, carbon dioxide and lithium ions in the electrolyte solution or the like react with each other to form lithium carbonate as described above by the preliminary charge, and air bubbles of carbon dioxide are effectively shrunk, reduced or eliminated.

The “preliminary charge” refers to preliminary charging performed after injection. The preliminary charge may not be performed up to a charge rate of 100%, and may be partial charging at a charge rate of less than 100%. The charge rate means a percentage of an amount of electricity to be charged with respect to a charge capacity when the energy storage device is fully charged from a fully discharged state.

[8] In the method for manufacturing an energy storage device according to [7], it is preferable that a temperature of the element case is higher than room temperature when the preliminary charging is performed. When the energy storage device is a lithium ion energy storage device, the preliminary charging is performed in a state where the temperature of the element case is high, so that the reaction in which carbon dioxide and lithium ions in the electrolyte solution become lithium carbonate is promoted, and air bubbles remaining in the electrode assembly can be more effectively shrunk, reduced, or eliminated.

[9] In the method for manufacturing an energy storage device according to [7] or [8], a combination of the degassing and the injection is preferably performed one or more times after the preliminary charging. When the preliminary charging is performed after the entire amount of the electrolyte solution sealed in the element case is injected, the electrolyte solution is easily ejected to the outside of the element case due to gas generation during the preliminary charging. Thus, the entire amount of the electrolyte solution sealed in the element case before the preliminary charging is not injected, and the remaining electrolyte solution is injected after the preliminary charging, so that it is possible to suppress ejection of the electrolyte solution to the outside of the element case during the preliminary charging.

[10] In the method for manufacturing an energy storage device according to any one of [1] to [9], it is preferable that the element case and the electrode assembly housed in the element case are heated in advance at the time of the injection. When the element case and the electrode assembly are heated, the temperature of the electrolyte solution to be injected also increases. As a result, the viscosity of the electrolyte solution decreases, and the electrode assembly is efficiently impregnated with the electrolyte solution.

[11] In the method for manufacturing an energy storage device according to any one of [1] to [10], it is preferable that the electrolyte solution is heated in advance at the time of the injection. Also in such a case, since the viscosity of the electrolyte solution is low, the electrode assembly is efficiently impregnated with the electrolyte solution.

[12] The method for manufacturing an energy storage device according to any one of [1] to [11] preferably further includes applying a centrifugal force to the element case in which the electrode assembly is housed and the electrolyte solution is injected after the injection. By applying the centrifugal force, the inside of the electrode assembly can be further impregnated with the electrolyte solution.

[13] In the method for manufacturing an energy storage device according to any one of [1] to [12], it is preferable that the electrode assembly is a winding-type electrode assembly in which the positive electrode and the negative electrode are wound in a state of being overlapped with each other, and a length of the electrode assembly in a winding axis direction is 300 mm or more. As described above, in the case of the winding-type electrode assembly which is long in the winding axis direction, it is generally difficult for the electrolyte solution to be impregnated particularly to a central portion of the electrode assembly, and air bubbles tend to remain in the electrode assembly. Thus, when one aspect of the present invention is applied in manufacturing an energy storage device including such an electrode assembly, an effect of efficiently injecting the electrolyte solution and reducing air bubbles remaining inside the electrode assembly is remarkably exhibited.

[14] In the method of manufacturing an energy storage device according to [13], the electrode assembly is preferably housed in the element case such that a surface of the element case including the plurality of electrolyte solution filling ports and a winding axis of the electrode assembly are parallel to each other. When the winding-type electrode assembly is housed in the element case such that the surface of the element case including the electrolyte solution filling port and the winding axis of the electrode assembly are parallel to each other, the electrode assembly is usually hardly impregnated with the electrolyte solution, and air bubbles are particularly likely to remain inside the electrode assembly. Thus, when one aspect of the present invention is applied in manufacturing the energy storage device having such a structure, an advantage that the electrolyte solution is efficiently injected and air bubbles remaining inside the electrode assembly is reduced is particularly remarkably exhibited.

[15] An electrolyte solution filling device according to another aspect of the present invention is used when an electrolyte solution is injected into an element case in which an electrode assembly including a positive electrode and a negative electrode is housed and a plurality of electrolyte solution filling ports are provided, and includes one electrolyte solution filling case, and a pipe for connecting the one electrolyte solution filling case and the plurality of electrolyte solution filling ports.

According to the electrolyte solution filling device according to [15], the electrolyte solution can be efficiently injected into the element case in which the electrode assembly is housed.

Hereinafter, a method for manufacturing an energy storage device according to an embodiment of the present invention, an electrolyte solution filling device, and other embodiments will be described in detail. It is to be noted that the names of the respective constituent members (respective constituent elements) for use in the respective embodiments may be different from the names of the respective constituent members (respective constituent elements) for use in the background art.

### <Method for Manufacturing Energy Storage Device>

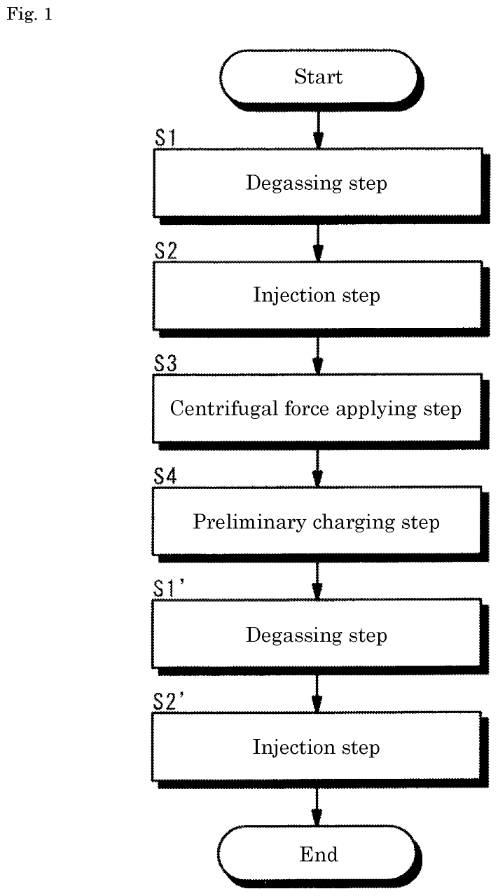

The method for manufacturing an energy storage device according to an embodiment of the present invention includes:
degassing the inside of the element case (degassing step S1);
injecting the electrolyte solution into the degassed element case (injection step S2);
applying a centrifugal force to the element case (centrifugal force applying step S3);
preliminary charging (preliminary charging step S4);
degassing the inside of the element case again (degassing step S1′); and
injecting an electrolyte solution into the degassed element case again (injection step S2′) (see FIG. 1).

Steps other than the degassing step S1 and the injection step S2 are arbitrary steps.

The method for manufacturing the energy storage device may further includes,
before the degassing step S1,
substituting carbon dioxide (CO₂) for a gas in the element case in which the electrode assembly is housed (CO₂ substitution step).

The method for manufacturing an energy storage device may include at least one of:
after the preliminary charging step S4,
compressing the element case (compression step);
sealing the electrolyte solution filling port of the element case with a plug, and welding the plug (sealing step); and
leaving the element case at a temperature of 35° C. or higher (high-temperature leaving step).

The method for manufacturing the energy storage device may further include a step (storage step, cleaning step, etc.) other than the above-mentioned step.

In the method for manufacturing an energy storage device, although the order of the steps is preferably the above order, the order is not limited to the above order as long as the same effect is obtained. In addition, a plurality of steps may be performed simultaneously, or the same step may be performed a plurality of times. For example, the centrifugal force applying step S3 may be performed after the injection step S2′, may be performed after the sealing step, or may be performed twice or more, in addition to after the injection step S2.

### (Structures of Electrode Assembly and Element Case)

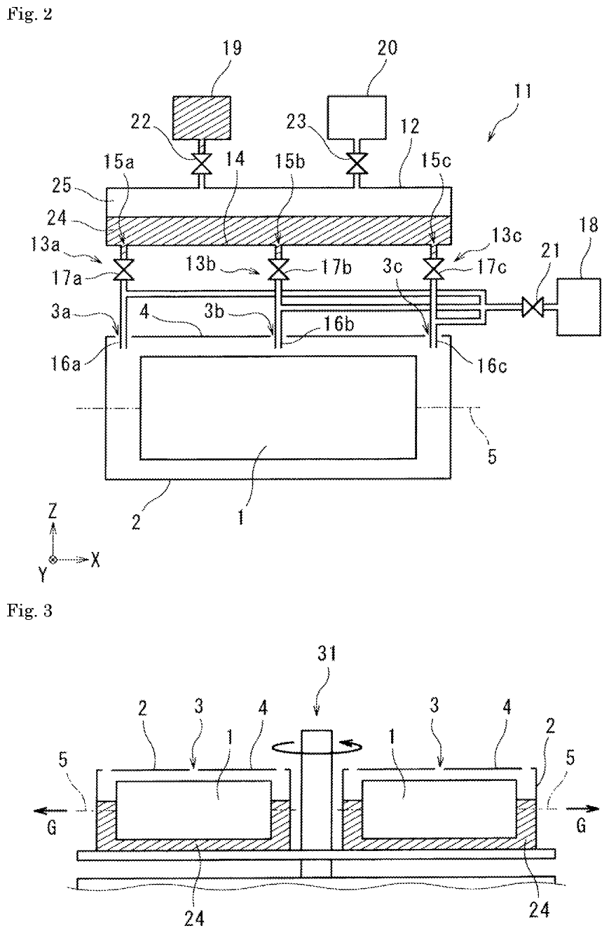

First, the structures and the like of the electrode assembly 1 and the element case 2 used in the present embodiment will be described with reference to FIG. 2. The electrode assembly 1 is a wound-type electrode assembly obtained by winding, around a winding axis 5, a band-shaped positive electrode and a band-shaped negative electrode stacked on one another with a band-shaped separator interposed therebetween. The electrode assembly 1 has a flat shape whose thickness direction is a direction orthogonal to the winding axis 5 (Y direction in FIG. 2). That is, the electrode assembly 1 is a flattened wound-type electrode assembly.

The lower limit of the length of the electrode assembly 1 in the winding axis direction (X direction in FIG. 2) may be, for example, 100 mm or 200 mm, and is preferably 300 mm, and more preferably 400 mm in some cases. The energy density of the energy storage device can be increased by making the electrode assembly 1 long in the winding axis direction as described above. On the other hand, when the electrode assembly 1 has a long structure in the winding axis direction, it is difficult to impregnate the electrode assembly 1 with the electrolyte solution up to the central portion of the electrode assembly 1, so that it is advantageous to apply one embodiment of the present invention. The upper limit of the length of the electrode assembly 1 in the winding axis direction may be, for example, 4,000 mm, 2,000 mm, 1,500 mm, or 1,000 mm.

The thickness (length in the Y direction in FIG. 2) of the electrode assembly 1 is preferably 5 mm or more and 50 mm or less, and more preferably 10 mm or more and 30 mm or less. The height (length in the Z direction in FIG. 2) of the electrode assembly 1 is preferably 40 mm or more and 300 mm or less, and more preferably 80 mm or more and 200 mm or less.

The element case 2 has a prismatic shape (rectangular parallelepiped shape). One surface (upper surface 4) of the element case 2 is provided with a plurality of (three in the present embodiment) electrolyte solution filling ports 3 (3a, 3b, 3c). The electrolyte solution filling ports 3a and 3c at both ends are preferably provided outside both ends of the electrode assembly 1 in a plan view (as viewed in the Z axis direction). When the electrolyte solution filling ports 3a and 3c at both ends are provided at such positions, the electrolyte solution injected from the electrolyte solution filling ports 3a and 3c at both ends quickly reaches the bottom side of the element case 2, and impregnation into the electrode assembly 1 is promoted.

The size of the element case 2 is appropriately set corresponding to the size of the electrode assembly 1. For example, the length of the element case 2 (the length in the X direction in FIG. 2) may be preferably 100 mm or more and 3,000 mm or less, more preferably 200 mm or more and 2,000 mm or less, still more preferably 300 mm or more and 1,500 mm or less, and even more preferably 400 mm or more and 1,000 mm or less in terms of the internal dimension. The thickness (length in the Y direction in FIG. 2) of the element case 2 is preferably 5 mm or more and 50 mm or less, and more preferably 10 mm or more and 30 mm or less in terms of the internal dimension. The height of the element case 2 (the length in the Z direction in FIG. 2) is preferably 40 mm or more and 300 mm or less, and more preferably 80 mm or more and 200 mm or less in terms of the internal dimension.

The material of the element case 2 is not particularly limited, and a resin case, a metal case or the like can be used; however, the element case 2 is preferably a metal case when the electrolyte solution filling port 3 is sealed by welding or the like.

The electrode assembly 1 is housed in the element case 2 such that a surface (upper surface 4 in FIG. 2) of the element case 2 including the plurality of electrolyte solution filling ports 3 and the winding axis 5 of the electrode assembly 1 are parallel to each other. In this embodiment, one electrode assembly 1 is housed in one element case 2. Although external terminals of the positive electrode and the negative electrode are not illustrated in FIG. 2, the positions of these terminals are arbitrary. For example, it is preferable that a positive electrode terminal and a negative electrode terminal are respectively provided on side surfaces (left and right surfaces in FIG. 2) of the element case 2. The positive electrode terminal and the negative electrode terminal may be provided on a surface (upper surface 4 in FIG. 2) provided with the plurality of electrolyte solution filling ports 3.

A method for housing the electrode assembly 1 in the element case 2 is not particularly limited, and the electrode assembly 1 can be housed in the element case 2 by a known method. For example, the electrode assembly 1 can be housed in the element case 2 by, for example, housing the electrode assembly 1 in the element case 2 (element case body) having an open shape without a lid portion corresponding to the upper surface 4, then covering an opening portion with a lid provided with the plurality of electrolyte solution filling ports 3 corresponding to the upper surface 4, and welding the lid and the element case body to each other. In each step described later, the element case 2 is usually placed such that the upper surface 4 provided with the plurality of electrolyte solution filling ports 3 is positioned on the upper side.

Specific forms of the positive electrode, the negative electrode, the separator, and the electrolyte solution constituting the electrode assembly 1 will be described in detail later.

### (Electrolyte Solution Filling Device)

Next, an electrolyte solution filling device 11 of the present embodiment will be described. The electrolyte solution filling device 11 includes an electrolyte solution filling case 12 and a pipe 13 (13a, 13b, 13c) for connecting the electrolyte solution filling case 12 and the plurality of electrolyte solution filling ports 3a, 3b, and 3c.

The electrolyte solution filling case 12 stores an electrolyte solution to be injected in the element case 2. The electrolyte solution filling case 12 may further store carbon dioxide. A bottom surface 14 of the electrolyte solution filling case 12 is provided with a plurality of (three in the present embodiment) discharge ports 15 (15a, 15b, 15c) as many as the plurality of electrolyte solution filling ports 3 (3a, 3b, 3c) provided in the element case 2, and pipes 13 (13a, 13b, 13c) are connected to the plurality of discharge ports 15, respectively. An injection nozzle 16 (16a, 16b, 16c) is provided at a tip of each of the pipes 13. The injection nozzle 16 has a structure that can be airtightly attached to the electrolyte solution filling port 3 of the element case 2. Each of the pipes 13 is provided with an injection valve 17 (17a, 17b, 17c).

The electrolyte solution filling device 11 further includes an exhaust unit 18, an electrolyte solution supply unit 19, and a carbon dioxide supply unit 20. The exhaust unit 18 degasses the inside of the element case 2 in a state where the injection nozzle 16 is attached to the electrolyte solution filling port 3, and an exhaust valve 21 is provided between the exhaust unit 18 and the injection nozzle 16. As the exhaust unit 18, for example, a decompression pump or the like can be used. The electrolyte solution supply unit 19 supplies the electrolyte solution to the electrolyte solution filling case 12, and an electrolyte solution supply valve 22 is provided between the electrolyte solution supply unit 19 and the electrolyte solution filling case 12. As the electrolyte solution supply unit 19, for example, a combination of a tank for storing the electrolyte solution and a pump connected to the tank can be used. The carbon dioxide supply unit 20 supplies carbon dioxide to the electrolyte solution filling case 12, and a carbon dioxide supply valve 23 is provided between the carbon dioxide supply unit 20 and the electrolyte solution filling case 12. As the carbon dioxide supply unit 20, a cylinder or the like for storing carbon dioxide can be used.

FIG. 2 schematically illustrates a state where an electrolyte solution 24 and carbon dioxide 25 are filled in the electrolyte solution filling case 12 before performing the injection in the injection step S2. Hereinafter, each step will be described in the order of one mode basically performed.

### (CO₂ Replacement Step)

In the CO₂ replacement step, which is an optional step, the gas inside the element case 2 in which the electrode assembly 1 is housed and the plurality of electrolyte solution filling ports 3 are provided is replaced with carbon dioxide (CO₂). From the CO₂ replacement step to the injection step S2, one set of the plurality of injection nozzles 16 is airtightly attached to each of the plurality of electrolyte solution filling ports 3 of the element case 2, and one set of the plurality of discharge ports 15a, 15b, and 15c of the electrolyte solution filling case 12 and one set of the plurality of electrolyte solution filling ports 3a, 3b, and 3c of the element case 2 are connected by the pipes 13a, 13b, and 13c, respectively. The electrolyte solution filling case 12 is disposed such that the bottom surface 14 is horizontal.

In the CO₂ replacement step, first, the inside of the element case 2 is degassed by operating the exhaust unit 18 in a state where at least the plurality of injection valves 17 are closed and the exhaust valve 21 is opened. At this time, for example, it is preferable to perform degassing until the inside of the element case 2 reaches 0.1 MPa or less, more preferably 0.05 MPa or less. Thereafter, the exhaust valve 21 is closed, and the plurality of injection valves 17 and the carbon dioxide supply valve 23 are opened in a state where the electrolyte solution supply valve 22 is closed, whereby the inside of the element case 2 is filled with carbon dioxide. Although at least one of the plurality of injection valves 17 may be opened, it is preferable to open all the injection valves 17 from the viewpoint of efficiency and the like. By such an operation, the gas inside the element case 2 can be replaced with carbon dioxide.

### (Degassing Step S1)

In the degassing step S1, the plurality of injection valves 17 are closed, the exhaust valve 21 is opened, and the exhaust unit 18 is operated to degas the inside of the element case 2 in which the electrode assembly 1 is housed. At this time, for example, it is preferable to perform degassing until the inside of the element case 2 reaches 0.1 MPa or less, more preferably 0.05 MPa or less.

### (Injection Step S2)

In the injection step S2, first, the electrolyte solution supply valve 22 and the carbon dioxide supply valve 23 are opened in a state where the plurality of injection valves 17 are closed, and the electrolyte solution supply unit 19 and the carbon dioxide supply unit 20 fill the electrolyte solution 24 and the carbon dioxide 25 in the electrolyte solution filling case 12. At this time, the amount of the electrolyte solution 24 is preferably adjusted so that the electrolyte solution filling case 12 is filled with the electrolyte solution 24 in an amount to be filled in one operation. For example, after the carbon dioxide supply valve 23 is first opened to fill the electrolyte solution filling case 12 with the carbon dioxide 25, the electrolyte solution supply valve 22 is opened to fill the electrolyte solution filling case 12 with a predetermined amount of the electrolyte solution 24 by the electrolyte solution supply unit 19. Since the electrolyte solution 24 can be injected dividedly in a plurality of times, the electrolyte solution filling case 12 may not be filled with the entire amount of the electrolyte solution 24 finally injected into the element case 2 at one time.

Next, by opening the plurality of injection valves 17 in a state where valves (exhaust valve 21, electrolyte solution supply valve 22, and carbon dioxide supply valve 23) other than the plurality of injection valves 17 are closed, the electrolyte solution and carbon dioxide are injected from the electrolyte solution filling case 12 into the degassed element case 2 through the plurality of pipes 13 and the plurality of electrolyte solution filling ports 3. That is, the electrolyte solution and carbon dioxide are continuously injected from the electrolyte solution filling case 12 into the degassed element case 2 through the plurality of pipes 13 and the plurality of electrolyte solution filling ports 3 (without being temporarily stored in another storage unit such as a storage tank or a metering pipe). The electrolyte solution injected into the element case 2 through the plurality of electrolyte solution filling ports 3 is mixed in the element case 2 and impregnated into the electrode assembly 1. At this time, the carbon dioxide supply valve 23 may be in an open state. It is preferable that the plurality of injection valves 17 (17a, 17b, 17c) are all opened at the same time.

At the time of the injection step S2, one set of the plurality of discharge ports 15 (15a, 15b, 15c) of the electrolyte solution filling case 12 and one set of the plurality of electrolyte solution filling ports 3 (3a, 3b, 3c) of the element case 2 is connected by the pipe 13 (13a, 13b, 13c), respectively, and the electrolyte solution filling case 12 is disposed such that the bottom surface 14 provided with the plurality of discharge ports 15 is horizontal. For this reason, in the injection step S2, the injection of the electrolyte solution is easily completed almost simultaneously from the plurality of discharge ports 15, and efficiency of the electrolyte solution injection operation is high.

The amount of the electrolyte solution injected into the element case 2 in this injection step S2 may be 100% by mass with respect to the total amount of the electrolyte solution finally injected into the element case 2, is preferably 95% by mass or less, and more preferably 90% by mass or less. By not injecting all of the total amount of the electrolyte solution before the preliminary charging in this manner, it is possible to suppress ejection of the electrolyte solution to the outside of the element case at the time of the preliminary charging. On the other hand, the amount of the electrolyte solution injected into the element case 2 in the injection step S2 may be preferably 50% by mass or more, and more preferably 60% by mass or more, 70% by mass or more, or 80% by mass or more with respect to the total amount of the electrolyte solution finally injected into the element case 2. By sufficiently injecting the electrolyte solution to some extent before the preliminary charging, the inside of the electrode assembly 1 is sufficiently impregnated with the electrolyte solution, and the effect of the preliminary charging can be enhanced.

In the injection step S2, the element case 2 and the electrode assembly 1 housed in the element case 2 are preferably heated in advance. In addition, in the injection step S2, the electrolyte solution 24 to be injected into the element case 2 is preferably heated in advance. In such a case, the viscosity of the electrolyte solution 24 decreases, and impregnation into the electrode assembly 1 is promoted. The temperatures of the electrode assembly 1, the element case 2 and the electrolyte solution 24 are, for example, preferably 35° C. or higher, and more preferably 40° C. or higher. The upper limit of these temperatures can be, for example, 70° C., 60° C., or 50° C.

At the end of the injection step S2, it is preferable to pressurize the inside of the electrolyte solution filling case 12 while the electrolyte solution filling case 12 and the element case 2 communicate with each other. With such an operation, the electrolyte solution 24 remaining in the electrolyte solution filling case 12 flows out from the discharge port 15, and the inside of the electrode assembly 1 is more sufficiently impregnated with the electrolyte solution. This pressurization can be performed by the carbon dioxide supply unit 20. For example, the inside of the electrolyte solution filling case 12 can be pressurized by opening and closing the carbon dioxide supply valve 23 in a state where the plurality of injection valves 17 are opened. The pressurization may be performed once or a plurality of times, and is preferably performed a plurality of times.

### (Centrifugal Force Applying Step S3)

In the method for manufacturing an energy storage device, a centrifugal force is preferably applied to the element case 2 in which the electrode assembly 1 is housed and the electrolyte solution 24 is injected at an arbitrary timing after the injection step S2. At this time, as schematically illustrated in FIG. 3, the element case 2 in which the electrode assembly 1 and the electrolyte solution 24 are housed is preferably rotated by a centrifugal force applying device 31 so that the centrifugal force G is applied along the direction of the winding axis 5 of the electrode assembly 1. With such rotation, impregnation of the electrode assembly 1 with the electrolyte solution 24 is promoted. When the element case 2 is rotated in this manner, leakage of the electrolyte solution 24 from the electrolyte solution filling port 3 is suppressed even when the electrolyte solution filling port 3 provided in the upper surface 4 of the element case 2 is not sealed.

### (Storage Step)

In the method for manufacturing an energy storage device, it is preferable to store the element case 2 in which the electrode assembly 1 and the electrolyte solution are housed for a predetermined time under a low dew point environment after the injection step S2 and before the preliminary charging step S4. That is, the method for manufacturing the energy storage device may further include a storage step. Accordingly, the inside of the electrode assembly 1 is sufficiently impregnated with the electrolyte solution. By storing the element case under a low dew point environment, it is possible to prevent the electrolyte solution from absorbing moisture and being ejected to the outside of the element case at the time of preliminary charging, and to suppress a variation in an open circuit voltage of the obtained energy storage device. When the element case 2 is stored under a low dew point environment, the element case 2 may be stored in a state where the electrolyte solution filling port 3 of the element case 2 is opened (state where the inside of the element case 2 is not sealed), or the element case 2 may be stored in a state where the electrolyte solution filling port 3 is temporarily sealed. From the viewpoint of suppressing absorption of moisture into the electrolyte solution, it is preferable that each step in which the element case 2 is not in a sealed state is performed under a low dew point environment. The “low dew point environment” refers to an environment having a dew point of −30° C. or lower.

The storage time is preferably 30 minutes or more and 4 hours or less, and more preferably 1 hour or more and 2 hours or less. When the storage time is set to be equal to or more than the above upper limit, the inside of the electrode assembly 1 can be more sufficiently impregnated with the electrolyte solution. When the storage time is set to be equal to or less than the above upper limit, productivity can be increased.

### (Preliminary Charging Step S4)

In the preliminary charging step S4, preliminary charging is performed on an uncompleted energy storage device (energy storage device in a state where the electrode assembly 1 and the electrolyte solution are housed in the element case 2 and are not sealed). In this preliminary charging, for example, it is preferable to perform charging up to a range of a charge rate of 5% or more and 50% or less, and it is more preferable to perform charging up to 10% or more and 30% or less. When the energy storage device is a lithium ion energy storage device, it is preferable that the preliminary charging is performed until the negative electrode potential becomes 100 mV vs. Li/Li⁺ or less. By performing such preliminary charging, the production of lithium carbonate by the reaction between carbon dioxide dissolved in the electrolyte solution in the element case 2 and lithium ions in the electrolyte solution sufficiently occurs, and the air bubbles remaining in the electrode assembly 1 are effectively shrunk, reduced, or eliminated.

The preliminary charging may be performed in a state where each of the electrolyte solution filling ports 3 of the element case 2 is opened (state where the inside of the element case 2 is not sealed), and in this case, the preliminary charging is preferably performed under a low dew point environment.

In the preliminary charging step S4, it is preferable that the temperature of the element case 2 is higher than room temperature, and it is more preferable that the temperature of the electrode assembly 1 is higher than room temperature together with the element case 2. When the energy storage device is a lithium ion energy storage device, by setting such a state, the generation of lithium carbonate by the reaction between carbon dioxide and lithium ions in the electrolyte solution or the like is promoted, and the air bubbles remaining in the electrode assembly 1 can be more effectively shrunk, reduced, or eliminated. The temperatures of the electrode assembly 1 and the element case 2 in the preliminary charging step S4 are, for example, preferably 35° C. or higher, and more preferably 40° C. or higher. The upper limit of the temperature can be, for example, 70° C., 60° C., or 50° C.

### (Degassing Step S1′ and Injection Step S2′)

As described above, after the preliminary charging step S4, the combination of the degassing step S1′ and the injection step S2′ can be performed again one or more times using the electrolyte solution filling device 11. Specific methods of the degassing step S1′ and the injection step S2′ performed after the preliminary charging step S4 are similar to the degassing step S1 and the injection step S2 performed before the preliminary charging step S4. However, the injection amount in each of the injection steps S2 and S2′ is adjusted such that the total injection amount of the electrolyte solution in the plurality of injection steps S2 and S2′ becomes the set total amount of the electrolyte solution injected into the element case 2. The combination of the degassing step S1′ and the injection step ST performed after the preliminary charging step S4 may be performed only once or may be performed twice or more. In the plurality of injection steps S2 and S2′, the composition of the injected electrolyte solution may be the same or different. By injecting carbon dioxide together with the electrolyte solution also in the injection step S2′ after the preliminary charging step S4, generation of the air bubbles and the like in the electrode assembly 1 can be suppressed, and the obtained energy storage device can exhibit good charge-discharge performance.

### (Compression Step)

In the compressing step, the expanded element case 2 is usually compressed by performing preliminary charging or the like. The element case 2 is preferably compressed so as to have a constant dimension equal to or less than at least the dimension of the element case 2 (for example, the thickness in the original rectangular parallelepiped shape). For example, the element case 2 may be compressed so that the side surface of the element case 2 is recessed. By compressing the element case 2, the obtained energy storage device can have a good shape, and can be brought into a state of exhibiting good charge-discharge performance.

### (Cleaning Step)

In the method for manufacturing an energy storage device, it is preferable to clean the periphery of each of the electrolyte solution filling ports 3 between the compression step and the sealing step. That is, the method for manufacturing the energy storage device may further include a cleaning step. When each of the electrolyte solution filling ports 3 is sealed by welding or the like without cleaning the periphery of each of the electrolyte solution filling ports 3, a welding defect may occur. Thus, the welding defect can be suppressed by cleaning the periphery of each of the electrolyte solution filling ports 3 before sealing. This cleaning is preferably performed by wiping off dirt (ejected electrolyte solution or the like) around each of the electrolyte solution filling ports 3 with paper, a nonwoven fabric or the like impregnated with an organic solvent. For example, when dry paper, nonwoven fabric, or the like is used, an electrolyte salt in the electrolyte solution tends to remain around each of the electrolyte solution filling ports 3. Thus, by using paper, a nonwoven fabric, or the like impregnated with an organic solvent, even this electrolyte salt can be sufficiently wiped off. As the organic solvent, an alcohol, a nonaqueous solvent used for an electrolyte solution, and the like are suitably used. Among them, the nonaqueous solvent used for the electrolyte solution is preferable, and in particular, a chain carbonate such as diethyl carbonate or dimethyl carbonate is more preferable. By using such an organic solvent, when these organic solvents are mixed in the element case 2, it is possible to suppress the generation of gas and the like due to the decomposition of these organic solvents at the positive electrode and the negative electrode of the energy storage device during charging and discharging.

The periphery of each of the electrolyte solution filling ports 3 is preferably cleaned under a low dew point environment. By performing the cleaning under a low dew point environment, it is possible to suppress swelling or the like of the element case 2 due to mixing of moisture into the element case 2.

### (Sealing Step)

In the sealing step, each of the electrolyte solution filling ports 3 is sealed with a plug in the state where the element case 2 is compressed, and the plug is welded to the element case 2. By performing the sealing in the state where the element case 2 is in the compressed state, it is possible to suppress swelling and to obtain an energy storage device having high uniformity in thickness.

As the plug used for sealing, a plug made of metal is suitably used. The plug is preferably made of the same material as the element case 2. For example, when the element case 2 is made of aluminum, it is preferable to use a plug made of aluminum. The plug can be suitably sealed by welding such as laser welding or resistance welding.

### (High-Temperature Leaving Step)

In the high-temperature leaving step, the element case 2 is left at a temperature higher than room temperature after preliminary charging. In a case where the energy storage device is a lithium ion energy storage device, in the high-temperature leaving step, after the negative electrode potential is set to 100 mV vs. Li/Li⁺ or less by preliminary charging, the element case 2 may be left at a temperature of 35° C. or higher in a state where the negative electrode potential is 100 mV vs. Li/Li⁺ or less. Apart from the preliminary charging step S4 performed before sealing, the element case 2 may be subjected to the high-temperature leaving step by performing preliminary charging again to set the negative electrode potential to 100 mV vs. Li/Li⁺ or less. By such a high-temperature leaving step, the production of lithium carbonate by the reaction between carbon dioxide and lithium ions in the electrolyte solution proceeds, and the air bubbles remaining in the electrode assembly 1 is further shrunk, reduced, or eliminated. The temperature of the environment where the element case 2 is left is preferably 35° C. or higher, and more preferably 40° C. or higher. The upper limit of the temperature can be, for example, 80° C., 60° C., or 50° C.

In addition, in the method for manufacturing the energy storage device, the energy storage device after the electrolyte solution filling port is sealed may be charged and discharged for activation treatment (formation treatment), capacity confirmation, and the like. In this charging and discharging, charging may be performed up to a charge rate of 100%, or charging may be performed at a charge rate of less than 100%.

Hereinafter, the positive electrode, the negative electrode, the separator, and the electrolyte solution used in the method for manufacturing an energy storage device according to one embodiment of the present invention will be described in detail.

### (Positive Electrode)

The positive electrode includes a positive substrate and a positive active material layer disposed directly on the positive substrate or over the positive substrate with an intermediate layer interposed therebetween.

The positive substrate has conductivity. Whether the positive substrate has “conductivity” or not is determined with the volume resistivity of 107 Ω·cm measured in accordance with JIS-H-0505 (1975) as a threshold.

As the material of the positive substrate, a metal such as aluminum, titanium, tantalum, or stainless steel, or an alloy thereof is used. Among these metals and alloys, aluminum or an aluminum alloy is preferable from the viewpoints of electric potential resistance, high conductivity, and cost. Examples of the positive substrate include a foil, a deposited film, a mesh, and a porous material, and a foil is preferable from the viewpoint of cost. Accordingly, the positive substrate is preferably an aluminum foil or an aluminum alloy foil. Examples of the aluminum or aluminum alloy include A1085, A3003, and A1N30 specified in JIS-H-4000 (2014) or JIS-H-4160 (2006).

The average thickness of the positive substrate is preferably 3 μm or more and 50 μm or less, more preferably 5 μm or more and 40 μm or less, still more preferably 8 μm or more and 30 μm or less, and particularly preferably 10 μm or more and 25 μm or less. The average thickness of the positive substrate falls within the range mentioned above, thereby making it possible to increase the energy density per volume of the energy storage device while increasing the strength of the positive substrate.

The intermediate layer is a layer disposed between the positive substrate and the positive active material layer. The intermediate layer includes a conductive agent such as carbon particles to reduce contact resistance between the positive substrate and the positive active material layer. The configuration of the intermediate layer is not particularly limited, and includes, for example, a binder and a conductive agent.

The positive active material layer includes a positive active material. The positive active material layer contains optional components such as a conductive agent, a binder, a thickener, a filler, or the like as necessary.

The positive active material can be appropriately selected from known positive active materials. As the positive active material for a lithium ion secondary battery, a material capable of occluding and releasing lithium ions is typically used. Examples of the positive active material include lithium-transition metal composite oxides that have an α-NaFeO₂-type crystal structure, lithium-transition metal composite oxides that have a spinel-type crystal structure, polyanion compounds, chalcogenides, and sulfur. Examples of the lithium-transition metal composite oxides that have an α-NaFeO₂-type crystal structure include Li[LiₓNi₍₁₋ₓ₎]O₂ (0≤x<0.5), Li[LiₓNi_{y}Co_{(1-x-γ)}]O₂ (0≤x<0.5, 0<γ<1, 0<1-x-γ), Li[LiₓCo₍₁₋ₓ₎]O₂ (0≤x<0.5), Li[LiₓNi_{γ}Mn_{(1-x-γ)}]O₂ (0≤x<0.5, 0<γ<1, 0<1-x-γ), Li[LiₓNi_{γ}Mn_{ß}Co_{(1-x-γ-β})]O₂ (0≤x<0.5, 0<γ, 0<ß, 0.5<γ+β<1, 0<1-x-y-ß), and Li[LiₓNi_{γ}Co_{ß}Al_{(1-x-γ-ß)}]O₂ (0≤x<0.5, 0<γ, 0<ß, 0.5<γ+ß<1, 0<1-x-γ-ß).

Examples of the lithium-transition metal composite oxides that have a spinel-type crystal structure include LiₓMn₂O₄ and LiₓNi_{γ}Mn_{(2-γ)}O₄. Examples of the polyanion compounds include LiFePO₄, LiMnPO₄, LiNiPO₄, LiCoPO₄, Li₃V₂(PO₄)₃, Li₂MnSiO₄, and Li₂CoPO₄F. Examples of the chalcogenides include a titanium disulfide, a molybdenum disulfide, and a molybdenum dioxide. Some of atoms or polyanions in these materials may be substituted with atoms or anion species composed of other elements. The surfaces of these materials may be coated with other materials. In the positive active material layer, one of these materials may be used singly, or two or more thereof may be used in mixture.

The positive active material is usually a particle (powder). The average particle size of the positive active material is preferably 0.1 μm or more and 20 μm or less, for example. By setting the average particle size of the positive active material to be equal to or more than the lower limit mentioned above, the positive active material is easily manufactured or handled. By setting the average particle size of the positive active material to be equal to or less than the upper limit mentioned above, the electron conductivity of the positive active material layer is improved. In the case of using a composite of the positive active material and another material, the average particle size of the composite is regarded as the average particle size of the positive active material. The “average particle size” means a value at which a volume-based integrated distribution calculated in accordance with JIS-Z-8819-2 (2001) is 50% based on a particle size distribution measured by a laser diffraction/scattering method for a diluted solution obtained by diluting particles with a solvent in accordance with JIS-Z-8825 (2013).

A crusher, a classifier, or the like is used in order to obtain a powder with a predetermined particle size. Examples of the crushing method include a method of using a mortar, a ball mill, a sand mill, a vibratory ball mill, a planetary ball mill, a jet mill, a counter jet mill, a whirling airflow-type jet mill, a sieve, or the like. At the time of crushing, wet-type crushing in coexistence of water or an organic solvent such as hexane can also be used. As a classification method, a sieve or a wind force classifier or the like is used based on the necessity both in dry manner and in wet manner.

The content of the positive active material in the positive active material layer is preferably 50% by mass or more and 99% by mass or less, more preferably 70% by mass or more and 98% by mass or less, and still more preferably 80% by mass or more and 95% by mass or less. By setting the content of the positive active material in the above range, it is possible to achieve both high energy density and productivity of the positive active material layer.

The conductive agent is not particularly limited as long as the agent is a material with conductivity. Examples of such a conductive agent include carbonaceous materials, metals, and conductive ceramics. Examples of the carbonaceous materials include graphite, non-graphitic carbon, and graphene-based carbon. Examples of the non-graphitic carbon include carbon nanofibers, pitch-based carbon fibers, and carbon black. Examples of the carbon black include furnace black, acetylene black, and ketjen black. Examples of the graphene-based carbon include graphene, carbon nanotubes (CNTs), and fullerene. Examples of the form of the conductive agent include a powdery form and a fibrous form. As the conductive agent, one of these materials may be used alone, or two or more thereof may be used in mixture. In addition, these materials may be used in combination. For example, a composite material of carbon black and CNT may be used. Among these materials, carbon black is preferable from the viewpoints of electron conductivity and coatability, and in particular, acetylene black is preferable.

The content of the conductive agent in the positive active material layer is preferably 1% by mass or more and 10% by mass or less, more preferably 3% by mass or more and 9% by mass or less. The content of the conductive agent falls within the range mentioned above, thereby allowing the energy density of the energy storage device to be increased.

Examples of the binder mentioned above include: thermoplastic resins such as fluororesins (e.g., polytetrafluoroethylene (PTFE), polyvinylidene fluoride (PVDF)), polyethylene, polypropylene, polyacryl, and polyimide; elastomers such as an ethylene-propylene-diene rubber (EPDM), sulfonated EPDM, a styrene butadiene rubber (SBR), and a fluororubber; and polysaccharide polymers.

The content of the binder in the positive active material layer is preferably 1% by mass or more and 10% by mass or less, more preferably 3% by mass or more and 9% by mass or less. By setting the binder content to the above range, the positive active material can be stably held.

Examples of the thickener include polysaccharide polymers such as a carboxymethylcellulose (CMC) and a methylcellulose. When the thickener mentioned above has a functional group that is reactive with lithium and the like, the functional group may be deactivated by methylation or the like in advance.

The filler is not particularly limited. Examples of the filler include polyolefins such as polypropylene and polyethylene, inorganic oxides such as silicon dioxide, alumina, titanium dioxide, calcium oxide, strontium oxide, barium oxide, magnesium oxide and aluminosilicate, hydroxides such as magnesium hydroxide, calcium hydroxide and aluminum hydroxide, carbonates such as calcium carbonate, hardly soluble ionic crystals of calcium fluoride, barium fluoride, and barium sulfate, nitrides such as aluminum nitride and silicon nitride, and substances derived from mineral resources, such as talc, montmorillonite, boehmite, zeolite, apatite, kaolin, mullite, spinel, olivine, sericite, bentonite and mica, or artificial products thereof.

The positive active material layer may contain a typical nonmetal element such as B, N, P, F, Cl, Br, and I, a typical metal element such as Li, Na, Mg, Al, K, Ca, Zn, Ga, Ge, Sn, Sr, and Ba, or a transition metal element such as Sc, Ti, V, Cr, Mn, Fe, Co, Ni, Cu, Mo, Zr, Nb, and W as a component other than the positive active material, the conductive agent, the binder, the thickener, and the filler.

### (Negative Electrode)

The negative electrode has a negative substrate and a negative active material layer disposed directly on the negative substrate or over the negative substrate with an intermediate layer interposed therebetween. The configuration of the intermediate layer is not particularly limited, and can be selected from the configurations exemplified for the positive electrode, for example.

The negative substrate has conductivity. As the material of the negative substrate, a metal such as copper, nickel, stainless steel, nickel-plated steel, or aluminum, an alloy thereof, a carbonaceous material, or the like is used. Among these metals and alloys, the copper or copper alloy is preferable. Examples of the negative substrate include a foil, a deposited film, a mesh, and a porous material, and a foil is preferable from the viewpoint of cost. Accordingly, the negative substrate is preferably a copper foil or a copper alloy foil. Examples of the copper foil include rolled copper foils and electrolytic copper foils.

The average thickness of the negative substrate is preferably 2 μm or more and 35 μm or less, more preferably 3 μm or more and 30 μm or less, still more preferably 4 μm or more and 25 μm or less, and particularly preferably 5 μm or more and 20 μm or less. When the average thickness of the negative substrate falls within the range mentioned above, the energy density per volume of the energy storage device can be increased while increasing the strength of the negative substrate.

The negative active material layer includes a negative active material. The negative active material layer contains optional components such as a conductive agent, a binder, a thickener, and a filler, if necessary. The optional components such as a conductive agent, a binder, a thickener, and a filler can be selected from the materials exemplified for the positive electrode.

The negative active material layer may contain a typical nonmetal element such as B, N, P, F, Cl, Br, or I, a typical metal element such as Li, Na, Mg, Al, K, Ca, Zn, Ga, Ge, Sn, Sr, and Ba or a transition metal element such as Sc, Ti, V, Cr, Mn, Fe, Co, Ni, Cu, Mo, Zr, Ta, Hf, Nb, or W as a component other than the negative active material, the conductive agent, the binder, the thickener, and the filler.

The negative active material can be appropriately selected from known negative active materials. As the negative active material for a lithium ion secondary battery, a material capable of absorbing and releasing lithium ions is usually used. Examples of the negative active material include metallic Li; metals or metalloids such as Si and Sn; metal oxides or metalloid oxides such as a Si oxide, a Ti oxide, and a Sn oxide; titanium-containing oxides such as Li₄Ti₅O₁₂, LiTiO₂, and TiNb₂O₇; a polyphosphoric acid compound; silicon carbide; and carbon materials such as graphite and non-graphitic carbon (easily graphitizable carbon or hardly graphitizable carbon). Among these materials, a material having a negative electrode potential of 1 V vs. Li/Li⁺ or less when lithium ions are occluded is preferable, Si, a Si oxide, and a carbon material are more preferable, the carbon material is still more preferable, and graphite and non-graphitizable carbon are even more preferable from the viewpoint that carbon dioxide and lithium ions in the electrolyte solution react with each other to form lithium carbonate and are easily fixed to the surface of the negative electrode. In the negative active material layer, one of these materials may be used alone, or two or more thereof may be used in mixture.

The term “graphite” refers to a carbon material in which the average lattice spacing (d₀₀₂) of the (002) plane determined by an X-ray diffraction method before charge-discharge or in a discharged state is 0.33 nm or more and less than 0.34 nm. Examples of the graphite include natural graphite and artificial graphite. Artificial graphite is preferable from the viewpoint that a material having stable physical properties can be obtained.

The term “non-graphitic carbon” refers to a carbon material in which the average grid spacing (d₀₀₂) of the (002) plane determined by an X-ray diffraction method before charge-discharge or in the discharged state is 0.34 nm or more and 0.42 nm or less. Examples of the non-graphitic carbon include hardly graphitizable carbon and easily graphitizable carbon. Examples of the non-graphitic carbon include a resin-derived material, a petroleum pitch or a material derived from petroleum pitch, a petroleum coke or a material derived from petroleum coke, a plant-derived material, and an alcohol derived material.

In this regard, the “discharged state” means a state discharged such that lithium ions that can be occluded and released in association with charge-discharge are sufficiently released from the carbon material as the negative active material. For example, the “discharged state” refers to a state where the open circuit voltage is 0.7 V or higher in a half cell that has, for use as a working electrode, a negative electrode containing a carbon material as a negative active material, and has metal Li for use as a counter electrode.

The “hardly graphitizable carbon” refers to a carbon material in which the d₀₀₂ is 0.36 nm or more and 0.42 nm or less.

The “easily graphitizable carbon” refers to a carbon material in which the d₀₀₂ is 0.34 nm or more and less than 0.36 nm.

The negative active material is typically particles (powder). The average particle size of the negative active material can be, for example, 1 nm or more and 100 μm or less. When the negative active material is a carbon material, a titanium-containing oxide, or a polyphosphoric acid compound, the average particle size thereof may be 1 μm or more and 100 μm or less. When the negative active material is Si, Sn, an oxide of Si, an oxide of Sn, or the like, the average particle size thereof may be 1 nm or more and 1 μm or less. By setting the average particle size of the negative active material to be equal to or greater than the above lower limit, the negative active material is easily produced or handled. By setting the average particle size of the negative active material to be equal to or less than the upper limit, the electron conductivity of the negative active material layer is improved. A crusher, a classifier, or the like is used in order to obtain a powder with a predetermined particle size. The crushing method and classification method can be selected from, for example, the methods exemplified for the positive electrode. When the negative active material is a metal such as metal Li, the negative active material layer may have the form of a foil.

The content of the negative active material in the negative active material layer is preferably 60% by mass or more and 99% by mass or less, more preferably 90% by mass or more and 98% by mass or less. The content of the negative active material falls within the range mentioned above, thereby allowing a balance to be achieved between the increased energy density and productivity of the negative active material layer.

### (Separator)

The separator can be appropriately selected from known separators. As the separator, for example, a separator composed of only a substrate layer, a separator in which a heat resistant layer containing heat resistant particles and a binder is formed on one surface or both surfaces of the substrate layer, or the like can be used. Examples of the form of the substrate layer of the separator include a woven fabric, a nonwoven fabric, and a porous resin film. Among these forms, a porous resin film is preferable from the viewpoint of strength, and a nonwoven fabric is preferable from the viewpoint of liquid retaining properties of the nonaqueous electrolyte. As the material for the substrate layer of the separator, for example, a polyolefin such as polyethylene or polypropylene is preferable from the viewpoint of shutdown function, and polyimide, aramid or the like is preferable from the viewpoint of resistance to oxidative decomposition. As the substrate layer of the separator, a material obtained by combining these resins may be used.

The heat resistant particles included in the heat resistant layer preferably have a mass loss of 5% or less in the case of temperature increase from room temperature to 500° C. under the air atmosphere of 1 atm, and more preferably have a mass loss of 5% or less in the case of temperature increase from room temperature to 800° C. Examples of materials that have a mass loss equal to or less than a predetermined value include inorganic compounds. Examples of the inorganic compound include oxides such as iron oxide, silicon oxide, aluminum oxide, titanium dioxide, zirconium oxide, calcium oxide, strontium oxide, barium oxide, magnesium oxide and aluminosilicate; nitrides such as aluminum nitride and silicon nitride; carbonates such as calcium carbonate; sulfates such as barium sulfate; hardly soluble ionic crystals such as calcium fluoride, barium fluoride, barium titanate; covalently bonded crystals such as silicon and diamond; and substances derived from mineral resources, such as talc, montmorillonite, boehmite, zeolite, apatite, kaolin, mullite, spinel, olivine, sericite, bentonite, and mica, and artificial products thereof. As the inorganic compounds, simple substances or complexes of these substances may be used alone, or two or more thereof may be used in mixture. Among these inorganic compounds, the silicon oxide, aluminum oxide, or aluminosilicate is preferable from the viewpoint of the safety of the energy storage device.

The porosity of the separator is preferably 80% by volume or less from the viewpoint of strength, and is preferably 20% by volume or more from the viewpoint of discharge performance. The term “porosity” herein is a volume-based value, and means a value measured with a mercury porosimeter.

As the separator, a polymer gel composed of a polymer and a nonaqueous electrolyte may be used. Examples of the polymer include a polyacrylonitrile, a polyethylene oxide, a polypropylene oxide, a polymethyl methacrylate, a polyvinyl acetate, a polyvinylpyrrolidone, and a polyvinylidene fluoride. The use of the polymer gel has the effect of suppressing liquid leakage. As the separator, the polymer gel may be used in combination with a porous resin film, a nonwoven fabric, or the like as described above.

### (Electrolyte Solution)

The electrolyte solution can be appropriately selected from known electrolyte solutions. The electrolyte solution is preferably a nonaqueous electrolyte solution. The nonaqueous electrolyte solution includes a nonaqueous solvent and an electrolyte salt dissolved in the nonaqueous solvent.

The nonaqueous solvent can be appropriately selected from known nonaqueous solvents. Examples of the nonaqueous solvent include cyclic carbonates, chain carbonates, carboxylic acid esters, phosphoric acid esters, sulfonic acid esters, ethers, amides, and nitriles. As the nonaqueous solvent, solvents in which some of the hydrogen atoms included in these compounds are substituted with halogen may be used.

Examples of the cyclic carbonates include ethylene carbonate (EC), propylene carbonate (PC), butylene carbonate (BC), vinylene carbonate (VC), vinylethylene carbonate (VEC), chloroethylene carbonate, fluoroethylene carbonate (FEC), difluoroethylene carbonate (DFEC), styrene carbonate, 1-phenylvinylene carbonate, and 1,2-diphenylvinylene carbonate. Among these carbonates, EC is preferable.

Examples of the chain carbonates include diethyl carbonate (DEC), dimethyl carbonate (DMC), ethyl methyl carbonate (EMC), diphenyl carbonate, trifluoroethyl methyl carbonate, and bis(trifluoroethyl)carbonate. Among these carbonates, EMC is preferable.

As the nonaqueous solvent, it is preferable to use the cyclic carbonate or the chain carbonate, and it is more preferable to use the cyclic carbonate and the chain carbonate in combination. The use of the cyclic carbonate allows the promoted dissociation of the electrolyte salt to improve the ionic conductivity of the nonaqueous electrolyte solution. The use of the chain carbonate allows the viscosity of the nonaqueous electrolyte solution to be kept low. When the cyclic carbonate and the chain carbonate are used in combination, the volume ratio of the cyclic carbonate to the chain carbonate (cyclic carbonate:chain carbonate) preferably falls within the range from 5:95 to 50:50, for example.

The electrolyte salt can be appropriately selected from known electrolyte salts. Examples of the electrolyte salt include a lithium salt, a sodium salt, a potassium salt, a magnesium salt, and an onium salt. Among these salts, the lithium salt is preferable.

Examples of the lithium salt include inorganic lithium salts such as LiPF₆, LiPO₂F₂, LiBF₄, LiClO₄, and LiN(SO₂F)₂, lithium oxalates such as lithium bis(oxalate)borate (LiBOB), lithium difluorooxalatoborate (LiFOB), and lithium bis(oxalate)difluorophosphate (LiFOP), and lithium salts having a halogenated hydrocarbon group, such as LiSO₃CF₃, LiN(SO₂CF₃)₂, LiN(SO₂C₂F₅)₂, LiN(SO₂CF₃)(SO₂C₄F), LiC(SO₂CF₃)₃, and LiC(SO₂C₂F₅)₃. Among these salts, the inorganic lithium salts are preferable, and LiPF₆ is more preferable.

The content of the electrolyte salt in the nonaqueous electrolyte solution is, at 20° C. under 1 atm, preferably 0.1 mol/dm³ or more and 2.5 mol/dm³ or less, more preferably 0.3 mol/dm³ or more and 2.0 mol/dm³ or less, still more preferably 0.5 mol/dm³ or more and 1.7 mol/dm³ or less, particularly preferably 0.7 mol/dm³ or more and 1.5 mol/dm³ or less. The content of the electrolyte salt falls within the range mentioned above, thereby allowing the ionic conductivity of the nonaqueous electrolyte solution to be increased.

The nonaqueous electrolyte solution may include an additive, besides the nonaqueous solvent and the electrolyte salt. Examples of the additive include halogenated carbonic acid esters such as fluoroethylene carbonate (FEC) and difluoroethylene carbonate (DFEC); oxalic acid salts such as lithium bis(oxalate)borate (LiBOB), lithium difluorooxalatoborate (LiFOB), and lithium bis(oxalate)difluorophosphate (LiFOP); imide salts such as lithium bis(fluorosulfonyl)imide (LiFSI); aromatic compounds such as biphenyl, alkylbiphenyl, terphenyl, partly hydrogenated terphenyl, cyclohexylbenzene, t-butylbenzene, t-amylbenzene, diphenyl ether, and dibenzofuran; partial halides of the aromatic compounds, such as 2-fluorobiphenyl, o-cyclohexylfluorobenzene, and p-cyclohexylfluorobenzene; halogenated anisole compounds such as 2,4-difluoroanisole, 2,5-difluoroanisole, 2,6-difluoroanisole, and 3,5-difluoroanisole; vinylene carbonate, methylvinylene carbonate, ethylvinylene carbonate, succinic anhydride, glutaric anhydride, maleic anhydride, citraconic anhydride, glutaconic anhydride, itaconic anhydride, cyclohexanedicarboxylic anhydride; ethylene sulfite, propylene sulfite, dimethyl sulfite, methyl methanesulfonate, busulfan, methyl toluenesulfonate, dimethyl sulfate, ethylene sulfate, sulfolane, dimethyl sulfone, diethyl sulfone, dimethylsulfoxide, diethylsulfoxide, tetramethylene sulfoxide, diphenyl sulfide, 4,4′-bis(2,2-dioxo-1,3,2-dioxathiolane, 4-methylsulfonyloxymethyl-2,2-dioxo-1,3,2-dioxathiolane, thioanisole, diphenyl disulfide, dipyridinium disulfide, 1,3-propene sultone, 1,3-propane sultone, 1,4-butane sultone, 1,4-butene sultone, perfluorooctane, tristrimethylsilyl borate, tristrimethylsilyl phosphate, tetrakistrimethylsilyl titanate, lithium monofluorophosphate, and lithium difluorophosphate. One of these additives may be used alone, or two or more thereof may be used in mixture.

The content of the additive contained in the nonaqueous electrolyte solution is preferably 0.01% by mass or more and 10% by mass or less, more preferably 0.1% by mass or more and 7% by mass or less, still more preferably 0.2% by mass or more and 5% by mass or less, particularly preferably 0.3% by mass or more and 3% by mass or less, with respect to a total mass of the nonaqueous electrolyte solution. The content of the additive falls within the range mentioned, thereby making it possible to improve capacity retention performance or cycle performance after high-temperature storage, and to further improve safety.

As the electrolyte solution, an electrolyte solution other than a nonaqueous electrolyte solution can also be used.

The energy storage device manufactured by the method for manufacturing an energy storage device according to the present embodiment can be mounted as an energy storage unit (battery module) configured with a plurality of energy storage devices assembled, on power sources for automobiles such as electric vehicles (EV), hybrid vehicles (HEV), and plug-in hybrid vehicles (PHEV), power sources for electronic devices such as personal computers and communication terminals, power sources for power storage, or the like.

### Other Embodiments

It is to be noted that the method for manufacturing an energy storage device according to the present invention is not limited to the embodiment mentioned above, and various changes may be made without departing from the scope of the present invention. For example, to the configuration of one embodiment, the configuration of another embodiment can be added, and a part of the configuration of one embodiment can be replaced by the configuration of another embodiment or a well-known technique. Furthermore, a part of the configuration according to one embodiment can be deleted. In addition, a well-known technique can be added to the configuration according to one embodiment.

For example, the electrolyte solution filling case may not be filled with carbon dioxide, a gas (for example, air) other than carbon dioxide may be filled, and this gas may be injected into the element case together with the electrolyte solution. In this case, the carbon dioxide supply unit 20 included in the electrolyte solution filling device of FIG. 2 may be a gas supply unit. However, by injecting carbon dioxide as a gas into the element case, the air bubbles remaining in the electrode assembly can be further reduced as described above. The inside of the energy storage device may be degassed from only some of the plurality of electrolyte solution filling ports.

The number of electrolyte solution filling ports provided on one surface (upper surface) of the element case is not particularly limited as long as the number is two or more. The number of the electrolyte solution filling ports is, for example, preferably 2 or more and 5 or less, and more preferably 3 or more and 4 or less.

In the above embodiment, although one electrode assembly is housed in one element case, the number of electrode assemblies housed in the element case is not limited thereto. For example, two or more electrode assemblies may be housed in one element case in a state of being connected in parallel. The number of electrode assemblies housed in the element case may be, for example, two to five, and typically two or three. As described above, even when two or more electrode assemblies are housed in one element case, the electrolyte solution can be efficiently injected into the element case in which the electrode assembly is housed by using the above-described electrolyte solution filling device. In the present specification, the “state where two or more electrode assemblies are connected in parallel” means a state where the positive electrodes are connected to each other and the negative electrodes are connected to each other in each electrode assembly and the electrode assemblies are electrically connected in parallel. Therefore, a state in which two or more electrode assemblies are electrically connected in series, such as a so-called monoblock type storage battery (storage battery in which an inside of one element case is partitioned into a plurality of parts by a partition wall, the storage battery includes a plurality of electrode assemblies housed in the respective parts, and the adjacent electrode assemblies are electrically connected in series), is excluded from this aspect.

In the above embodiment, although the case where the energy storage device is used as a lithium ion secondary battery has been mainly described, the type, shape, size, capacity, and the like of the energy storage device are arbitrary. The present invention can also be applied to capacitors such as lithium ion capacitors. The method for manufacturing an energy storage device of the present invention can also be applied to a method for manufacturing an energy storage device including a stacked-type electrode assembly, an energy storage device including an element case other than a prismatic case, or the like.

### INDUSTRIAL APPLICABILITY

The present invention can be applied to a method for manufacturing an energy storage device and the like used as a power source for electronic devices such as personal computers and communication terminals, automobiles, and the like.

### DESCRIPTION OF REFERENCE SIGNS

1: electrode assembly
2: element case
3 (3a, 3b, 3c): electrolyte solution filling port
4: upper surface
5: winding axis
11: electrolyte solution filling device
12: electrolyte solution filling case
13 (13a, 13b, 13c): pipe
14: bottom surface
15 (15a, 15b, 15c): discharge port
16 (16a, 16b, 16c): injection nozzle
17 (17a, 17b, 17c): injection valve
18: exhaust unit
19: electrolyte solution supply unit
20: carbon dioxide supply unit
21: exhaust valve
22: electrolyte solution supply valve
23: carbon dioxide supply valve
24: electrolyte solution
25: carbon dioxide
31: centrifugal force applying device

1. A method for manufacturing an energy storage device comprising:
degassing an inside of an element case in which an electrode assembly including a positive electrode and a negative electrode is housed and a plurality of electrolyte solution filling ports are provided on one surface; and
injecting an electrolyte solution from one electrolyte solution filling case filled with the electrolyte solution into the inside of the degassed element case through the plurality of electrolyte solution filling ports.

2. The method for manufacturing an energy storage device according to claim 1, wherein the one electrolyte solution filling case is further filled with carbon dioxide at the time of the injection.

3. The method for manufacturing an energy storage device according to claim 1, wherein the electrolyte solution filling case is filled with an electrolyte solution in an amount to be injected as the electrolyte solution in one operation at the time of the injection.

4. The method for manufacturing an energy storage device according to claim 1, wherein
the one electrolyte solution filling case has a bottom surface provided with a plurality of discharge ports as many as the plurality of electrolyte solution filling ports of the element case,
at the time of the injection, in a plurality of discharge ports of the one electrolyte solution filling case and the plurality of electrolyte solution filling ports of the element case, each pair is connected by a pipe, and the one electrolyte solution filling case is disposed in such a way that the bottom surface is horizontal.

5. The method for manufacturing an energy storage device according to claim 4, wherein each of the pipes includes a valve, and the respective valves are simultaneously opened at the time of the injection.

6. The method for manufacturing an energy storage device according to claim 1, wherein at the end of the injection, the inside of the one electrolyte solution filling case is pressurized in a state where the one electrolyte solution filling case and the element case are communicated with each other.

7. The method for manufacturing an energy storage device according to claim 1, further comprising performing preliminary charging after the injection.

8. The method for manufacturing an energy storage device according to claim 7, wherein a temperature of the element case is higher than room temperature when the preliminary charging is performed.

9. The method for manufacturing an energy storage device according to claim 7, wherein a combination of the degassing and the injection is performed one or more times after the preliminary charging.

10. The method for manufacturing an energy storage device according to claim 1, wherein the element case and the electrode assembly housed in the element case are heated in advance at the time of the injection.

11. The method for manufacturing an energy storage device according to claim 1, wherein the electrolyte solution is heated in advance at the time of the injection.

12. The method for manufacturing an energy storage device according to claim 1, further comprising applying a centrifugal force to the element case in which the electrode assembly is housed and the electrolyte solution is injected after the injection.

13. The method for manufacturing an energy storage device according to claim 1, wherein
the electrode assembly is a winding-type electrode assembly in which the positive electrode and the negative electrode are wound in a state of being overlapped with each other, and
a length of the electrode assembly in a winding axis direction is 300 mm or more.

14. The method for manufacturing an energy storage device according to claim 13, wherein the electrode assembly is housed in the element case in such a way that a surface of the element case including the plurality of electrolyte solution filling ports and a winding axis of the electrode assembly are parallel to each other.

15. An electrolyte solution filling device being used when an electrolyte solution is injected into an element case in which an electrode assembly including a positive electrode and a negative electrode is housed and a plurality of electrolyte solution filling ports are provided,
the electrolyte solution filling device comprising:
one electrolyte solution filling case; and
a pipe for connecting the one electrolyte solution filling case and the plurality of electrolyte solution filling ports.
